(19) United States
(12) Patent Application Publication
(10) Pub. No.: US 2020/0193261 A1
(43) Pub. Date: Jun. 18, 2020

(54) METHOD, SYSTEM, AND APPARATUS FOR RFID-INTEGRATED WOVEN LABEL

(71) Applicant: AVERY DENNISON RETAIL INFORMATION SERVICES LLC, Mentor, OH (US)

(72) Inventor: Mathieu de Backer, Grottammare (AP) (IT)

(21) Appl. No.: 16/717,133

(22) Filed: Dec. 17, 2019

Related U.S. Application Data
(60) Provisional application No. 62/780,618, filed on Dec. 17, 2018.

(51) Int. Cl. G06K 19/077

(52) U.S. Cl. CPC G06K 19/07773; G06K 19/07718

(57) ABSTRACT

A method, system, and apparatus for a label with integrated radio frequency identification (RFID) capabilities is shown and described. In exemplary embodiments, a woven or non-woven base may be utilized for an RFID inlay to be printed thereon. A pressure sensitive or thermo-adhesive layer may then be applied to the woven or non-woven base. These RFID printed woven or non-woven bases can then be die cut on rolls and applied to the back of woven labels.

### CROSS REFERENCE TO RELATED APPLICATION(S)

The present application claims priority from U.S. Provisional Application No. 62/780,618 filed Dec. 17, 2018, which is incorporated by herein by reference in its entirety.

### FIELD OF THE INVENTION

The present invention relates generally to woven labels. More specifically, the present invention relates to RFID-integrated woven labels.

### BACKGROUND

Woven labels are provided on various types of apparel and wearable items in order to provide information about the product, such as brand, care instructions, and place of manufacture, along with other information. In order to make woven labels more durable and more functional, the labels can include a polyethylene terephthalate (PET) inlay. The PET or Poly Propylene inlay provides an additional stiffness to the woven label, but can also cause discomfort to the wearer. For example, on a traditional shirt, the woven label will often be disposed on the inside of the shirt at or about the neck level of the wearer. A woven label with a PET inlay can cause discomfort to the wearer, for example, by rubbing against the skin.

To mitigate the problems associated with woven labels with PET inlays, alternative solutions have been developed. A Woven or non-woven base with or without coating based inlay, such as Avery Dennison's SmartFace® product, is configured to be included as part of the woven label in a similar fashion as the PET inlays described above. The Woven or non-woven base with or without coating based inlays, however, are significantly softer and provide enhanced wearer comfort.

However, due to the size of labels used with apparel, there is limited space to provide product information. Additionally, it is undesirable to include additional labels on the inside portions of apparel due to concerns related to comfort of the wearer and it is not desired to include labels on exterior portions of apparel due to appearance concerns. Thus, traditional woven labels offer minimal space to provide a consumer, shipper, or distributer with product information.

### SUMMARY

In an exemplary embodiment, a method, system, and apparatus for a woven label with integrated radio frequency identification (RFID) capabilities may be shown and described. In exemplary embodiments, a woven or non-woven base with or without base may be utilized for an RFID inlay to be printed thereon. A pressure sensitive adhesive or thermos-adhesive backing layer may then be applied to the paper base. These RFID printed paper inlays can then be die cut on rolls and applied to the back of woven labels.

According to some aspects of the present disclosure, a label comprises a label base and a RFID inlay, wherein the RFID inlay comprises a RFID inlay substrate, a RFID antenna, and an integrated circuit. In some embodiments, the label further comprises an adhesive layer, and in some embodiments, the RFID inlay is secured to the label base by the adhesive layer. In some embodiments, the adhesive layer comprises one or more of a pressure sensitive adhesive and a thermo-adhesive. In some embodiments, the RFID inlay is sewn to the label base.

In some embodiments, the label base is a fabric material. The fabric material may be a woven fabric. For example, the woven fabric may be one of a linen, denim, twill, satin, chiffon, corduroy, tweed, or canvas. In some embodiments, the RFID inlay substrate is one of a polyester film, polyethylene terephthalate film, or polyimide film. In some embodiments, the RFID inlay substrate is a fabric material. The fabric material of the RFID inlay substrate may be a woven fabric. For example, the woven fabric of the RFID inlay substrate may be one of a linen, denim, twill, satin, chiffon, corduroy, tweed, or canvas. The woven fabric of the RFID inlay substrate may be a natural fabric or a synthetic fabric. In some embodiments, the RFID inlay substrate is a paper-based material.

In some embodiments, the RFID antenna is printed on the RFID inlay substrate. In some embodiments, the RFID antenna is printed using conductive inks. In some embodiments, the RFID antenna is a metal foil applied to the RFID inlay substrate. In some embodiments, the metal foil is adhered to the RFID inlay substrate using one or more of a pressure sensitive adhesive and a thermo-adhesive. In some embodiments, the metal foil is laminated to the RFID inlay substrate. In some embodiments, the RFID antenna is formed from conductive threads stitched into the RFID inlay substrate.

In some embodiments, the RFID antenna and the integrated circuit are positioned between the RFID inlay substrate and the label base when the RFID inlay substrate is secured to the label base. In some embodiments, the RFID antenna and the integrated circuit are positioned on an anterior surface of the RFID inlay substrate, and a posterior surface of the RFID inlay substrate is secured to the label base. In some embodiments, a coating or other protective layer is applied on the RFID inlay substrate over the RFID antenna and the integrated circuit. In some embodiments, the coating is one of a polyester film, a polyethylene terephthalate film, or a polyimide film.

According to some aspects of the present disclosure, a method of producing a label comprises providing a length of a label base, providing a length of an RFID inlay substrate comprising a plurality of RFID inlays, and securing at least a portion of the length of the RFID inlay substrate to at least a portion of the length of the label base. In some embodiments, the securing step comprises one or more of attaching by a pressure sensitive adhesive, a thermo-adhesive, or sewing.

In some embodiments, each of the plurality of RFID inlays comprises an RFID antenna and in integrated circuit. In some embodiments, the method further comprises forming each RFID antenna on the RFID inlay substrate by one of printing with a conductive ink, applying a metal foil, or stitching with conductive threads. In some embodiments, the method further comprises attaching each integrated circuit to each RFID antenna. In some embodiments, each integrated circuit is attached directly to each RFID antenna. In some embodiments, each integrated circuit is attached to each RFID antenna using a strap or interposer device.

In some embodiments, the method further comprises performing a partial die cut around at least a portion of each of the plurality of RFID inlays. In some embodiments, the partial die cut defines at least a portion of a border surrounding each of the plurality of RFID inlays. In some embodiments, the partial die cut is made in the RFID inlay substrate prior to the securing step. In some embodiments, the partial die cut is made in the RFID inlay substrate and the label base after the securing step. In some embodiments, the method further comprises separating the length of the label base between each of the plurality of RFID inlays to form a plurality of individual RFID labels.

In some embodiments, the method further comprises encoding information on each of the plurality of RFID inlays. In some embodiments, the encoding step occurs before the securing step. In some embodiments, the encoding step occurs during or after the securing step. In some embodiments, the label base is secured to the RFID inlay substrate such that each of the plurality of RFID inlays is positioned between the label base and the RFID inlay substrate.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

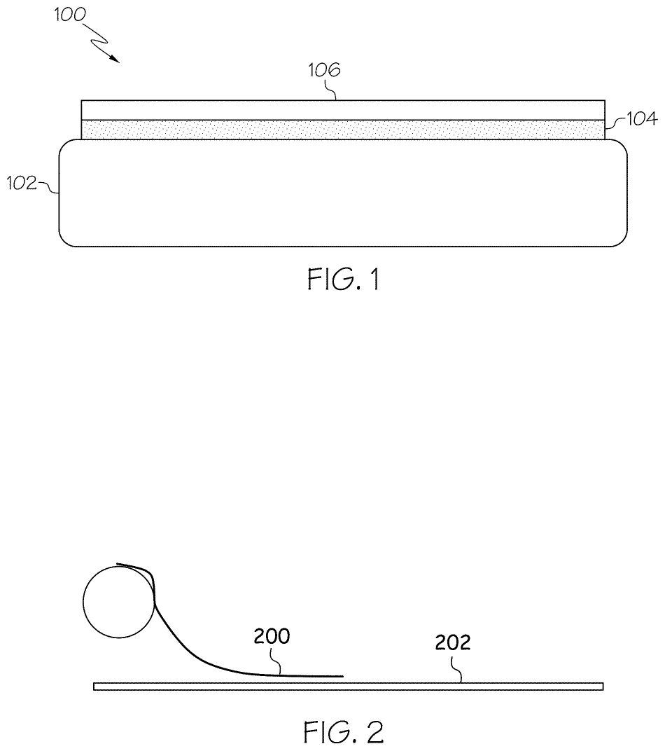

Exemplary FIG. 1 provides a view of a woven label with an integrated RFID antenna and inlay;

Exemplary FIG. 2 shows a view of a carrier for a die cut fabric base material having an RFID antenna and inlay disposed thereon;

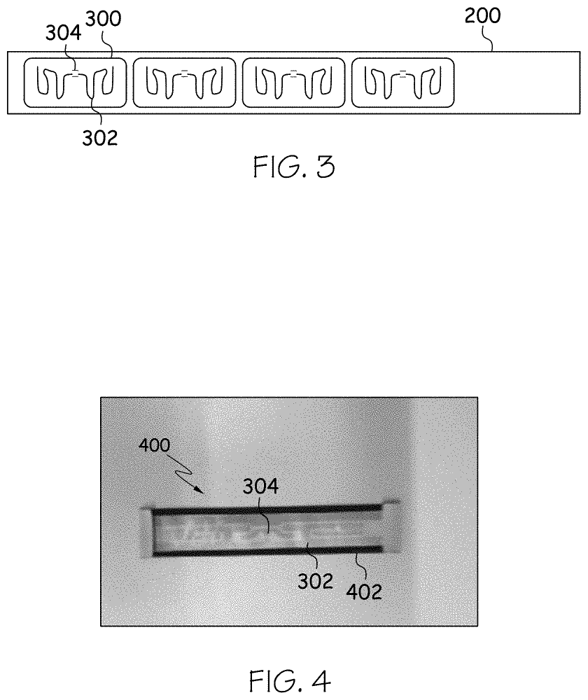

Exemplary FIG. 3 shows another view of the carrier with the die cut fabric base material having an RFID antenna and inlay disposed thereon; and

Exemplary FIG. 4 shows another view of a woven label with an integrated RFID antenna and inlay.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Generally referring to the figures, various aspects related to a woven label with integrated radio frequency identification (RFID) capabilities are shown and described, including methods of manufacture and use. In exemplary embodiments, a fabric base may be utilized for an RFID inlay. A pressure sensitive or thermo-adhesive backing layer may then be applied to the fabric base. These tags can then be die cut on rolls and applied to the back of woven labels.

Referring now to exemplary FIG. 1, a label with RFID capabilities 100 is shown. The label with RFID capabilities 100 may include a label 102. Label 102 may be formed in known manners for forming, for example, woven or non-woven apparel labels, such as those used on shirts and other garments. Further, it may be appreciated that any desired type of fabric may be utilized in the formation of label 102. For example, woven fabrics may be, but are not limited to linen, denim, twill, satin, chiffon, corduroy, tweed, and canvas. Label 102 may further serve as a base element for label with RFID capabilities 100.

An RFID inlay may comprise an RFID antenna and RFID chip (also referred to generally as an “integrated circuit”) and may be formed on an anterior portion of an inlay substrate 106. The inlay substrate 106 may be any material that is used with traditional woven labels, including, for example, polyester films, polyethylene terephthalate films, polyimide films, fabric (woven, non-woven, natural, and synthetic), or paper-based material (card stock, bond paper, bank paper, etc.). In some embodiments, a paper-based inlay, such as Avery Dennison's SmartFace® paper-based inlay, is used. The inlay substrate 106 may have the RFID antenna and integrated circuit printed thereon in any desired fashion of printing RFID labels, and the RFID inlay elements may generally be formed from aluminum, copper, silver, gold, alloys of various metals, or any other conductive metal foil or conductive ink, as desired.

Specific configurations and design considerations of the RFID inlay, including the components thereof (such as RFID antenna and/or integrated circuit) will be understood by a person of ordinary skill in the art. For example, RFID inlay may be selected to operate in a low frequency (“LF”) band (e.g., 30 KHz to 300 KHz), a high frequency (“HF”) band (e.g., 3 to 30 MHz), or an ultra-high frequency (“UHF”) band (e.g., 300 MHz to 3 GHz). In some embodiments, RFID inlay includes a dipole antenna tuned to operate in one or both of 902-928 MHz and 865-868 MHz frequency bands. In some embodiments, RFID inlay is configured for direct chip attachment. In other embodiments, RFID chip or integrated circuit is attached to a strap or interposer device, which in turn is attached to RFID antenna.

On a posterior portion of the inlay substrate 106, an adhesive layer 104 may be applied. Adhesive layer 104 may be a pressure sensitive adhesive or thermo-sensitive adhesive, in some embodiments. Adhesive layer 104 may be applied to inlay substrate 106 in any desired fashion. For example, adhesive layer 104 may be patterned onto or flood coated onto the posterior portion of inlay substrate 106. Adhesive layer 104 may be used to substantially permanently couple inlay substrate 106 to label 102 to form a label with RFID capabilities 100, as shown in exemplary FIGS. 1 and 4.

In another exemplary embodiment, it may be appreciated that the RFID antenna and integrated circuit may be formed on the inlay substrate 106 such that the RFID antenna and integrated circuit face the label 102 on the posterior portion of inlay substrate 106. In other words, RFID antenna and integrated circuit may be sandwiched between inlay substrate 106 and label 102. In this manner, RFID antenna and integrated circuit can be protected from potential damage.

In some embodiments, inlay substrate 106 is a fabric support, for example, any fabric material, such as any woven or non-woven, natural or synthetic material. In some embodiments, inlay substrate 106 may comprise an anti-fray fabric material. In such an exemplary embodiment, the fabric support could then be coupled with the label 102 via an adhesive layer 104, which may be a pressure sensitive adhesive or thermo-adhesive, as shown in FIG. 1. In other embodiments in which inlay substrate 106 is provided as a fabric support, inlay substrate 106 may be adhered or coupled to label 102 in any other known manner, as desired. For example, fabric support inlay substrate 106 may be sewn to label 102. Further, it may be appreciated that the RFID antenna and integrated could be printed on an anterior portion of the fabric support inlay substrate 106 or a posterior portion of the fabric support inlay substrate 106 so that RFID antenna and integrated circuit are proximate the label 102 when adhered or coupled to inlay substrate 106.

In still another exemplary embodiment, it is envisioned that an RFID antenna and integrated circuit may be generally formed from a conductive material, such as a conductive metal, including aluminum, and printed directly to a label 102 without another base material via an adhesive. In such an embodiment, the RFID antenna and integrated circuit may be printed in a similar fashion to printing on the inlay substrate 106, which may be a paper-based material or any other material suitable for an RFID substrate, as discussed herein.

Referring now to exemplary FIG. 2, the formation of labels with RFID capabilities may be shown. In this embodiment, a carrier 200 formed from a die cut base material, such as a paper-based material or a fabric, having an RFID antenna and integrated circuit is provided. The carrier 200 may then be disposed on and coupled to a base material 202. In some embodiments, base material 200 is a woven material that may be the formed as the basis for a traditional woven or printed fabric label. As may further be seen in exemplary FIG. 3, for example, a top view of the carrier 200 with die cut base material 300 with the RFID antenna 302 and integrated circuit 304 may be shown. This may then be disposed on and coupled to the base material 202, as shown in FIG. 2, for example using. In some embodiments, carrier 200 is secured to base material 202 by a pressure sensitive adhesive or thermo-adhesive, as described above. A resulting web of labels with RFID capabilities 100 may thus be formed.

One embodiment of an individual label with RFID capabilities is shown, for example, in FIG. 4. The label with RFID capabilities 400 may be configured according to the embodiments contemplated elsewhere herein, and may be utilized with garment and other apparel items as would be appreciated by a person of ordinary skill in the art. In some embodiments, label with RFID capabilities 400 is secured to a garment by sewing a portion of label 402 directly to the garment. For example, label with RFID capabilities 400 may be attached to a garment or other apparel item. For example, label 402 portion of label with RFID capabilities 400 may be sewn into or along a garment seam (e.g., the neckline of a shirt, dress, sweater, sweatshirt, coat, or vest, or the waistband of a pair of pants, shorts, or a skirt) or otherwise incorporated into an item (e.g., sewn, adhered, or otherwise attached to a shoe, such as to a shoe tongue). In some embodiments, label 402 portion of label with RFID capabilities 400 may be sewn along one or more edges to a garment or other apparel item. In some embodiments, label 402 portion of label with RFID capabilities 400 may be adhered to a garment or other apparel item. In some embodiments, label with RFID capabilities 400 is attached to a garment or other apparel item such that an RFID antenna 302 and integrated circuit 304 is positioned between label 402 and garment or apparel item. In this manner, RFID antenna 302 and integrated circuit 304 may be protected from damage.

The label with RFID capabilities 100 may provide numerous advantages over traditional woven and printed fabric labels. For example, information can be effectively coded and stored with each label 100 in integrated circuit 304, which can be queried by an RFID reader (not shown). As a result, more information can be provided from the product itself. For example, instead of being limited to information regarding apparel brand, size, care instructions, and location of manufacture, a piece of apparel with a label with RFID capabilities 100 can utilize the RFID capabilities to provide inventory information, tracking information, and/or any other information that may be encoded on or associated with the RFID inlay.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by persons skilled in the art without departing from the scope of the invention as defined by the following claims.

What is claimed is:

1. A label comprising:
a label base; and
a RFID inlay comprising
a RFID inlay substrate,
a RFID antenna, and
an integrated circuit.

2. The label of claim 1, further comprising an adhesive layer, wherein the RFID inlay is secured to the label base by the adhesive layer.

3. The label of claim 2, wherein the adhesive layer comprises one or more of a pressure sensitive adhesive and a thermo-adhesive.

4. The label of claim 1, wherein the RFID inlay is sewn to the label base.

5. The label of claim 1, wherein the label base is a fabric material.

6. The label of claim 5, wherein the fabric material is a woven fabric.

7. The label of claim 1, wherein the RFID inlay substrate is one of a polyester film, a polyethylene terephthalate film, a polyimide film, a fabric material, or a paper-based material.

8. The label of claim 1, wherein the RFID antenna is printed on the RFID inlay substrate.

9. The label of claim 1, wherein the RFID antenna and the integrated circuit are positioned between the RFID inlay substrate and the label base when the RFID inlay substrate is secured to the label base.

10. A method of producing a label, comprising:
providing a length of a label base;
providing a length of an RFID inlay substrate comprising a plurality of RFID inlays; and
securing at least a portion of the length of the RFID inlay substrate to at least a portion of the length of the label base.

11. The method of claim 10, wherein the securing step comprises one or more of attaching by a pressure sensitive adhesive, a thermo-adhesive, or sewing.

12. The method of claim 10, wherein each of the plurality of RFID inlays comprises an RFID antenna and in integrated circuit.

13. The method of claim 12, further comprising forming each RFID antenna on the RFID inlay substrate by one of printing with a conductive ink, applying a metal foil, or stitching with conductive threads.

14. The method of claim 12, further comprising attaching each integrated circuit to each RFID antenna.

15. The method of claim 14, wherein each integrated circuit is attached directly to each RFID antenna.

16. The method of claim 14, wherein each integrated circuit is attached to each RFID antenna using a strap or interposer device.

17. The method of claim 10, further comprising performing a partial die cut around at least a portion of each of the plurality of RFID inlays.

18. The method of claim 10, further comprising separating the length of the label base between each of the plurality of RFID inlays to form a plurality of individual RFID labels.

19. The method of claim 10, further comprising encoding information on each of the plurality of RFID inlays.

20. The method of claim 10, wherein the label base is secured to the RFID inlay substrate such that each of the plurality of RFID inlays is positioned between the label base and the RFID inlay substrate.
